(19) United States
(12) Patent Application Publication
(10) Pub. No.: US 2002/0068605 A1
(43) Pub. Date: Jun. 6, 2002

(54) Manual mobile-communication interface

(76) Inventor: Winfield Scott Stanley, Tucson, AZ (US)

Correspondence Address: Winfield Scott Stanley III, Suite 130, 118 S. 5th Ave., Tucson, AZ, 85701, US

(21) Appl. No.: 09/924,133

(22) Filed: Aug. 8, 2001

Related U.S. Application Data
(60) Provisional application No. 60/223,104, filed on Aug. 3, 2000.

(51) Int. Cl. H04M 1/00

(52) U.S. Cl. 455/556; 455/566; 455/550

(57) ABSTRACT

A mechanical user-interface for a wireless communications device (including cell phones, mobile phones, and computer-based wireless communications devices) enabling a motor-vehicle operator to keep both hands on the steering wheel while manually initiating, receiving, terminating, fielding or otherwise transacting wireless communications. This mechanical user interface (MUI) may be understood to operate as a cell-phone and/or wireless-communication keypad coupled to an automobile's steering wheel. By use of the MUI, a vehicle operator may then manually initiate, receive, terminate, field, and otherwise transact phone calls/communications via a host or integrated cell-phone or other wireless communications device, thereby eliminating the need to take his hands from the wheel in the context of these operations. The MUI keypad includes, but is not limited to the many features of cell phone and computer-based communication devices. The MUI may then connect to a headset through use of infra-red sensors, rf signal, or direct-wire connect. The device enables a user to operate keypad functions, and speak on the phone without the need to withdraw his hands from the steering wheel while operating a motor vehicle. The mechanical user interface may house, but not be limited to housing, cell-phone transmit/receive circuitry.

### FIELD

This invention relates to a mechanical user interface (MUI) for cell phones and other wireless communication devices used in motor vehicles (including cell phones, mobile phones, and computer-based wireless communications devices), providing means and method by which a motor-vehicle operator may manually operate a keypad while placing the face of both palms along the steering wheel. Concurrently, the MUI provides the user with the means and method for manually reading and operating the keys of a communication's keypad by touch, rather than sight.

### BACKGROUND OF THE INVENTION

Mechanical user interfaces for cell phones presently require drivers to momentarily withdraw their hands and attention, respectively, from the steering wheel and the road. Recent Federal study has questioned whether use of current cell-phone design potentially interferes with motor vehicle operation, diminishing a driver's apparent attention to the road. Additionally, the same Federal study* also takes under consideration the question of the phone-call initiation period, questioning its hazards in connection with factors related to available MUI design. (*An Investigation of the Safety Implications of Wireless Communication in Vehicles, DOT HS 808-635, November 1997)

Available cell-phone MUI designs for use in motor vehicles necessitate that vehicle operators compromise attention to vehicle operations, while they are engaged in manually operating cell-phone fascia input controls. At key stages during phone calls, available MUI designs encourage and necessitate vehicle operators to momentarily withdraw hands and attention from the steering wheel and road, respectively. According to Federal study DOT HS 808-635,

“Dialing of telephone numbers is shown to be the most dangerous, considering its characteristics: visual distraction and splitting of attention while driving with one hand. This is true even for the hands-off type of phone.”(pp 233)

Current methods and procedures inherent in the use of available MUI design for car phones represent road dangers and a higher risk of accident for car-phone user and non-user alike. According to Federal study DOT HS 808-635,

“A total of 26,798 cellular telephone calls were made during the 14 month study period. The risk of collision when using a cellular telephone was four times higher than the risk when a cellular phone was not being used.”(pp 235).

Presently available mechanical user interfaces for cell phones used in motor vehicles are potentially awkward for drivers in various driving scenarios and have been questioned, using statistical models, as a potential hazard (An investigation of the Safety Implications of Wireless Communication in Vehicles, DOT HS 808-635, November 1997). Such available designs do not provide for a vehicle operator keeping both hands on the wheel while manually initiating, or fielding calls. Such designs do not provide an operator with an available method for dialing strictly by touch while manually initiating and fielding phone calls.

Accordingly, it is the objective of the present invention to provide both an ancillary and integrated mechanical user interface for a cell phone or other wireless communications device used in a motor vehicle that enables a vehicle operator to make, field, and engage in two-way wireless communication while maintaining a two-handed grip on the steering wheel and visual attention to the road.

### SUMMARY OF THE INVENTION

To achieve the forgoing and other objectives there is provided a mechanical user interface, which includes in its preferred embodiment a flexible key pad which couples to a motor vehicle's steering wheel and may additionally secure with Velcro strips. The interface includes, but is not limited to, all of the function keys available for use with wireless communications devices (including cell phones, mobile phones, and computer-based wireless communications devices). Additional attachment to the MUI may include an LC display registering activity on available cell phone functions. Key MUI functions include but are not limited to: number/primary keys (0-9,*,#), talk, end, redial, hold, voicemail, volume, mute, go to headset, go to speaker-phone, memory functions: incoming and out-going call records, phone book, button lock-out/freeze, internet access.

Positioning of the MUI's LCD allows a motor vehicle's operator to view the MUI display within a visual range which also encompasses the motor vehicle's display console: typically including speed, fuel level, and temperature gauges. The MUI display functions, then, are within the vehicle operator's same visual scope as the road and other gauges common to most motor vehicles. The LC display may in various embodiments be moved or enlarged for maximum visibility vis a vis the line of sight by the operator to the road. The MUI's display may in various models be positioned at the steering wheel's center or placed on the dash console.

The Device may operate under its own battery power, under that of the host cell, or in concert with the host automobile's own electrical harness.

Finger groove/s set in the MUI allow a user to quickly orient hand position relative to key placement, allowing a user to dial by touch rather than sight. Buttons are then quickly distinguished at the touch by their shape and feel, allowing a user to orient thumb and finger position in tandem with finger grooves for dialing by touch rather than sight. Raised demarcations along fascia additionally express button orientation to user further assisting MUI use by touch. Sounds produced by key depression unique to each function further reinforce operation of Device without visual cues.

The preferred embodiments of the invention presented here are described in the Figures and Detailed Description. Unless specifically noted, it is intended that the words and phrases in the specification and claims are given the ordinary and accustomed meaning to those of ordinary skill in the applicable arts. If any other special meaning is intended for any word or phrase, the specification will clearly state and define the special meaning.

Likewise, the use of the words “function” or “means” in the Detailed Description is not intended to indicate a desire to invoke the special provisions of 36 U.S.C. 112, Paragraph 6, to define the invention.

To the contrary, if the provisions of 35 U.S.C. 112, Paragraph 6. Are sought to be invoked to define the invention, the claims will specifically state the phrases “means for” or “step for” and a function, without also reciting in such phrases any structure, material or act in support of the function. Even when the claims recite a “means for” or “step for” performing a function, if they also recite any structure, materials or acts in support of that means or step, then the intention is not to invoke the provisions of 35 U.S.C. 112, Paragraph 6. Moreover, even if the provisions of 35 U.S.C. 112, Paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, material or acts for performing the claimed function.

For example, the preferred embodiment is particularly directed at placing fascia controls for wireless communication devices directly on the steering wheel conjoined with tactile descriptors for operational methods by touch. The application of these by-touch methods will vary with alternate design embodiments while maintaining operational methods consistent with user operation on the basis of touch without requisite visual cues. As an additional example, although preferred embodiment is particularly directed at placing fascia controls for a cellular phone directly on the steering wheel, device might additionally integrate or house other wireless communications including internet or satellite connectivity.

The Device may function as a mechanical interface between user and a wireless communications device in several ways:

1) Direct wire connect from MUI to host phone: connection would effectively bi-pass and/or link with the host phone's integral key-pad interface operations, thereby shifting the host phone's (key pad interface) face-plate functions to the new mechanical interface. Voice interface link with user would be established through either a headset or speaker-phone function. Connect to headset or speakerphone function may be made through either infrared, rf, or direct wire connects.

2) Infrared connect from mechanical interface to headset and host phone, relaying voice, digital, numeric and/or analog information.

3) Rf signal connect from mechanical interface to headset and host phone, relaying voice, digital, numeric and/or analog information.

4) Mechanical interface may additionally house cell phone circuitry and speakerphone function for voice interface with user thereby requiring no additional links to user cell-phones or to out-port voice interfaces such as a headset.

5) Headset may additionally house cell phone circuitry with connection options to mechanical user interface, including rf signal, infrared, or direct wire connection.

6) Mechanical user interface may additionally house cell-phone circuitry, and internet connectivity and function, with further incorporation of flexible-polymer cell-phone circuit technology such as U.S. Pat. No. 5,965,848 thereby establishing a complete housing, user interface, and receive/transmit mobile phone unit utilizing either speaker phone or headset as voice interface with user.

7) Alternate connection options between mechanical user interface, voice interface, and send/receive circuitry may include variations and multiple combinations of those delineated above.

8) Device's display may be enlarged and its location shifted to the center of steering wheel, or to driver console, or incorporated into transparent imaging heads-up display on windshield.

### BRIEF DESCRIPTION OF THE DRAWING

FIG. 1 is a front perspective view of a preferred embodiment of the present invention displaying fascia operations and functions.

FIG. 1a is a rear perspective view of a preferred embodiment of the present invention displaying numeric key functions, housing contours, and key positions.

FIG. 2 is a front perspective view of a preferred embodiment of the present invention displaying fascia operations and functions.

FIG. 2a is a rear perspective view of a preferred embodiment of the present invention displaying numeric key functions, housing contours, and key positions.

FIG. 3 depicts rf link between MUI, host phone, headset or clip-mic. Depicts interface options linking MUI to host cell-phone and voice/speech user interface

FIG. 3a is a front perspective view of a preferred embodiment of the present invention as coupled to a steering wheel displaying: visual display; key functions, shapes, and positioning; and housing contour.

FIG. 4a-4d are perspective flow charts depicting stages of manual operation, method for hands-on use, and finger-reach parameters inherent in design.

FIG. 5 depicts headset for infrared interface with MUI.

### DETAILED DESCRIPTION

For purposes of clarity, the term “wireless communications device” has been elected for primary descriptive use rather than identifiers “cell phone” or “mobile phone” or “car phone.” While the Device is certainly designed for interface with wireless communications devices including mobile phones, car phones, and computer based wireless communications devices, it is primarily within the context of use within a motor vehicle for which the Device is structured for use. The Device is not limited for exclusive use with cell phones designed for use within a motor vehicle. But rather, it is additionally designed as a mechanical user interface for bridging the safe use of wireless communications devices used both in and out of motor vehicles. The Device is designed to operate in concert with wireless communications devices which may operate both in and out of a motor vehicle.

The device is designed to interface, in one embodiment, with what is termed the “host phone.” The host phone being generally defined here as a wireless communications device operated within a motor vehicle for which the Device then operates as an ancillary manual user-interface for operational functions.

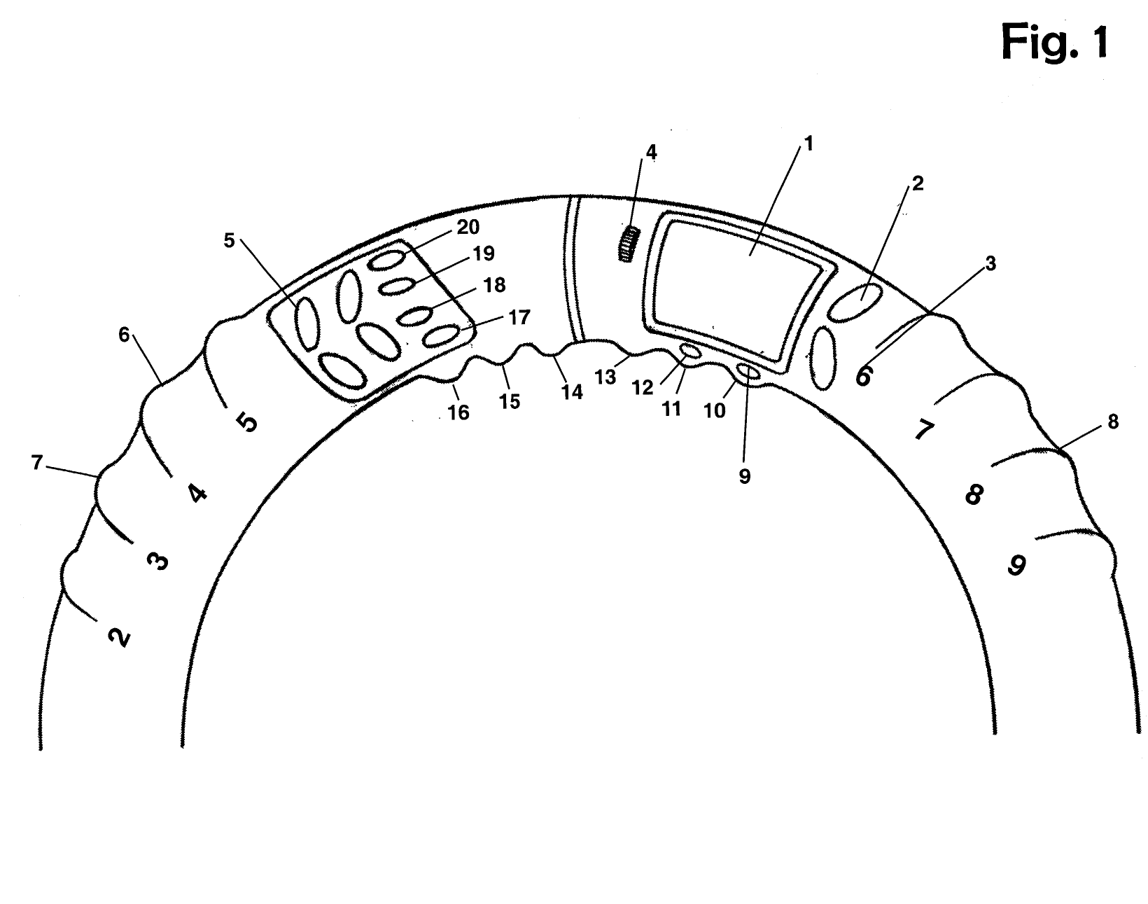

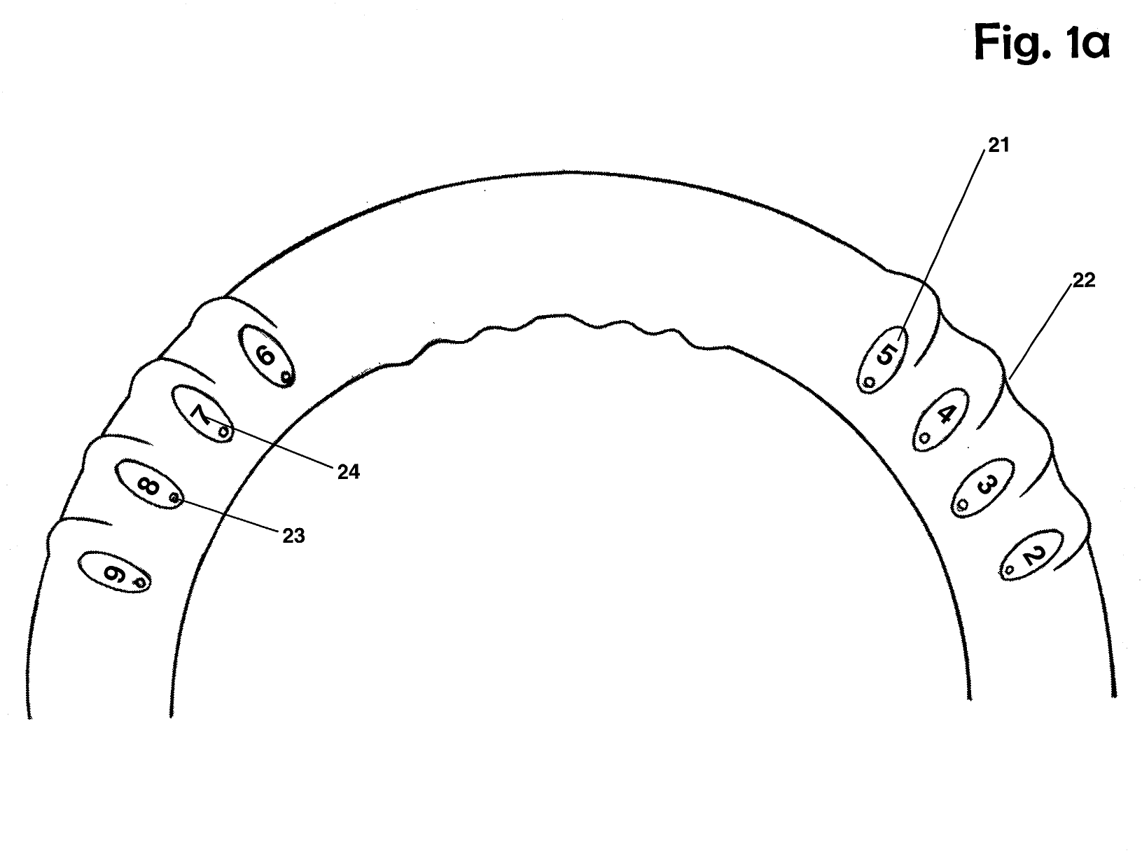

The following is a detailed description of the Device as an embodiment of a mechanical user interface in accordance with the present invention. FIG. 1 is a perspective view of this embodiment as it may appear to a user. This embodiment manifests as a mechanical housing with an LC display 1, 41, 58 and key pad 2-24 whose key functions are similar but not limited to those of standard cell-phones and personal mobile communications devices. Key functions include but are not limited to: number/primary keys (0-9, *, #), talk, end, redial, hold, voicemail, volume, mute, go to headset, go to speaker-phone, one/two-hand mode, button lock-out/freeze, memory functions: incoming and out-going call records, phone book. FIGS. 1, 1a, 2, 2a, 3, 3a, 4a-d include keys whose meaning and function in relation to the current net of interlaced cell-phone and mobile-phone technology may be delineated by but not limited to the following descriptions:

(0, 1, *, #)—As the most commonly used keys for initiating calls keys “0, 1, *, #” are placed 5, 31, 36 in the thumb position for ready dialing.

(2, 3, 4, 5) (6, 7, 8, 9)—Are placed at the finger-tip position for touch dialing either in the rear FIG. 1a, 2a or front FIG. 1, 2, 3 of housing and for either left and/or right hand or both. Numbers may be stationed at differing positions along housing 38, 39 to accommodate user preference and hand size. Keys may be depressed either at the front or the back of housing depending on unit's active mode 20 or model.

POWER—Device is powered on automatically when host phone inserted in holster. Power may additionally be turned on or off manually 4.

SEND—Send button 16 may be used to initiate phone dialing. It is a standard function key on most cell phones.

END—End button 15 may be used to complete or terminate phone call. It is a standard function key on most cell phone.

REDIAL—Redial function typically folded into other keys such as # button with many cell phones.

VOICEMAIL—As part of memory dial function, connects user into voicemail 9.

INTERNET ACCESS—As part of memory dial function, connects user to internet 9. “0” and “1” buttons 2, 5 operate as UP and DOWN scrolling functions while connected to internet. “1” functions as UP, “0” functions as DOWN.

VOLUME—Raises or lowers volume of headset or speakerphone. “0” and “1” buttons 2, 5 operate as UP and DOWN volume control during voice operations. “1” functions as UP, “0” functions as DOWN.

GO TO HEADSET: Transfers speech/voice interface to headset 12.

GO TO SPEAKERPHONE: Transfers user speech/voice interface to speakerphone 12.

ONE/TWO-HAND MODE: Allows MUI user to switch operation from a two to a one-handed setting. In one-handed setting, user may operate MUI with a single-hand. Keys may be given multiple designations allowing a user to expand operations beyond the limited number of keys for control of full operations with only the use of one hand 20. Logarithmic use of keys may allow user to expand operations well beyond a limited number of keys. Logarithmic functions incorporated into key use may allow typing, for instance, the full range of the alphabet with 9 keys or less.

VIBRATION CALL-ALERT FUNCTION: According to federal study (DOT HS 808 635) the startle created by a ringing telephone has been identified as a possible problem by some drivers. Use of vibration, a gradual increase in ring volume, or use of voice alerts may be appropriate alternative. Here a gentle vibration alert would be sent through the steering wheel from the MUI to announce an incoming call 12.

CLEAR—Clears last entry 18.

BUTTON LOCK-OUT FREEZE: Freezes and unfreezes the use of phone keys, avoiding unintentional initiation, interruption, or termination of phone calls while driving 17.

MEMORY FUNCTIONS: Includes incoming and out-going call records, and personal phonebook 19. Additionally, MUI links user with host cell-phone memory. Memory displayed on MUI LCD. Memory function 9 allows user to scroll numbers displayed on LCD and select a number previously dialed or stored otherwise in memory.

DISPLAY—LCD 1 allows user to view above operational functions. Display is positioned within MUI fascia and/or shifted to alternate locations while maintaining LCD position within vehicle operator's immediate range of site to road and motor vehicle console. Display may be enlarged in terms of total display surface area and positioned along rim of steering wheel, center of steering wheel, within gauge console or along upper tier of drivers side dashboard. It may also be established as a translucent headsup display positioned on or within the windshield itself. In the case of the display being positioned as a translucent entity on or within the windshield, its ideal position would be located as a column or line circumscribing the operator's central field of vision. Notwithstanding, MUI LCD position on the steering wheel itself affords the vehicle operator a clear line of sight to the display within the vehicle operator's immediate visual scope for viewing the road and console. This marks an improvement to prior art in terms of a vehicle operator's visual access to a cell-phone display, especially when factoring in manual control of both the vehicle and cell phone. Visual access to the cell-phone display is noteworthy since Federal study DOT HS 808 635 notes that, “. . . if more than four looks are required to dial the telephone number, then it is considered unacceptable from a driver safety and performance point of view, as it relates to lane exceedance probability. Also, the length of time per look should not exceed 2.0, 1.8, 1.6, 1.4 seconds for 1, 2, 3, and 4 looks respectively.”

The MUI housing itself may be compartmentalized into multiple sections of varying dimension to facilitate a snug physical coupling with the steering wheel. Alternate embodiments may be modeled as a single housing. For example, key pads for the left and right hand 7, 8 may be embodied in separate housings as may the LC display, with connecting links between all three; or key pad, LC display, battery source, and alternate circuitry models as described further may be embodied in a single housing. Battery power may, additionally, be placed in separate housing or may be sourced directly from host cell-phone or mastered through the vehicle electrical harness.

For models not manufactured directly into the steering wheel itself, housing may be made in part of leather or other material such as Nylon or Mylar consistent with flexibility and durability sufficient for regular daily use while driving. The device may be wrapped around or otherwise coupled to a steering wheel 52, 63 as well as readily detached through the use of Velcro or other such means as determines a secure fit 59.

Since some keys are placed at the rear of the fascia 21-24, 38, 39 device may include as shown 3 some numeric decaling allowing for visual recognition of numbers by user. Numeric decaling may be raised as necessary for recognition by touch as well as sight.

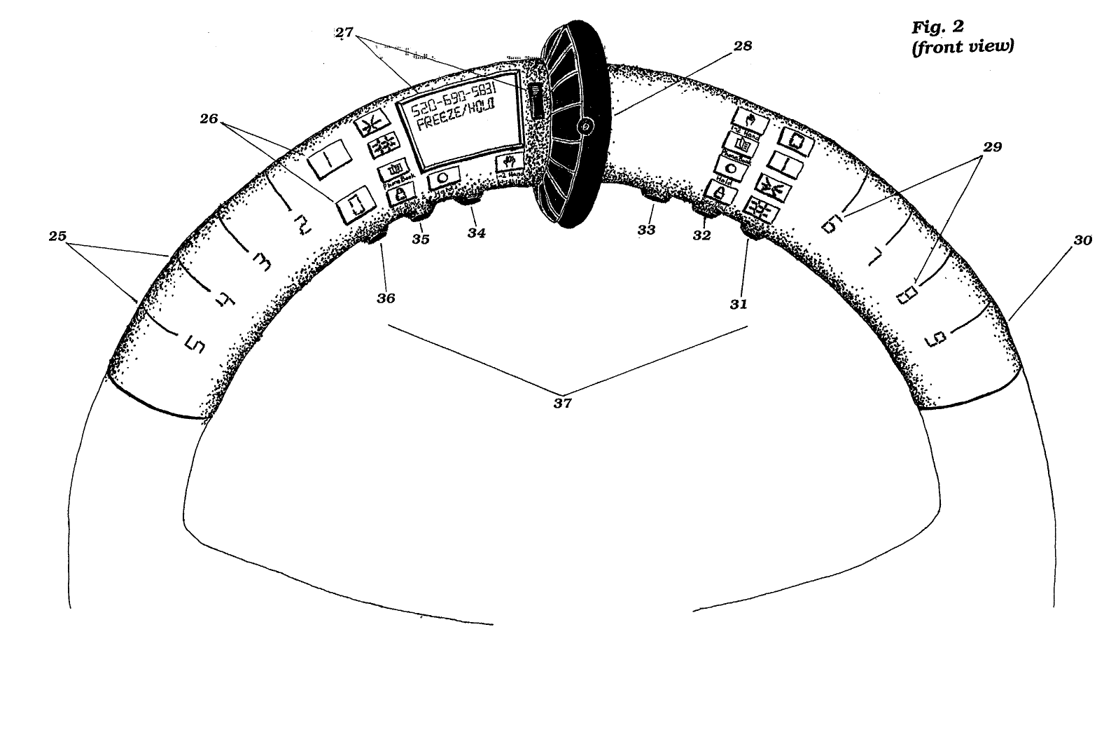

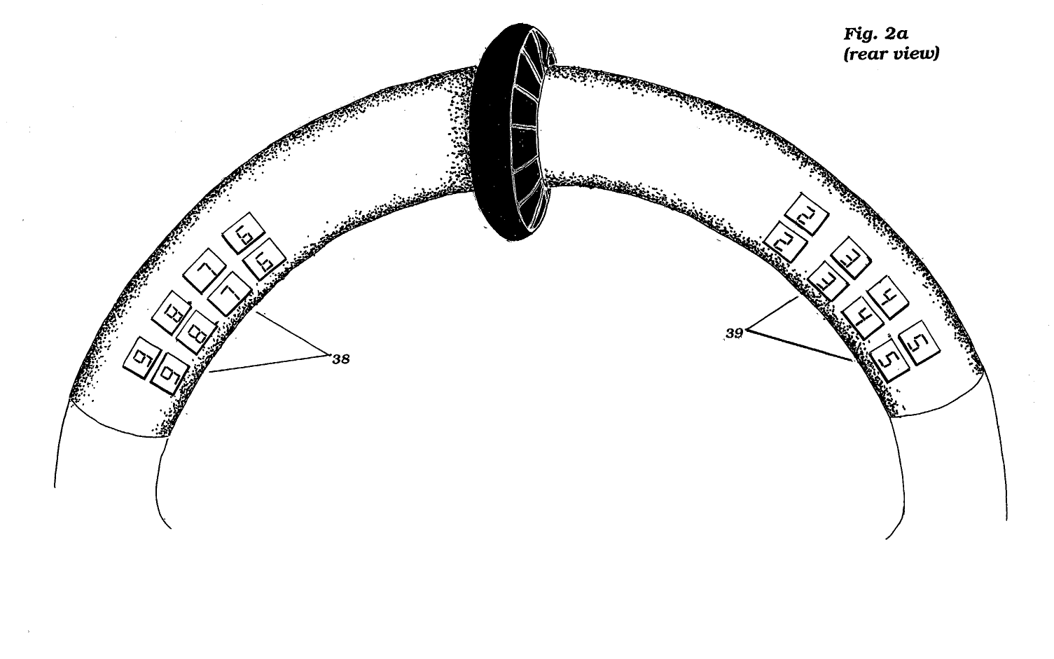

In FIG. 2 center housing 28 may hold various components including a power source. The center housing 28 may relay rf voice and numeric signals to voice/speech interface. Center housing 28 may contain rf relay interchange between the MUI, host cell phone, and voice/speech interface. Components within center housing 28 may vary dependent on model type or embodiment to include battery power source, two-way wireless communication circuitry and internet access circuitry.

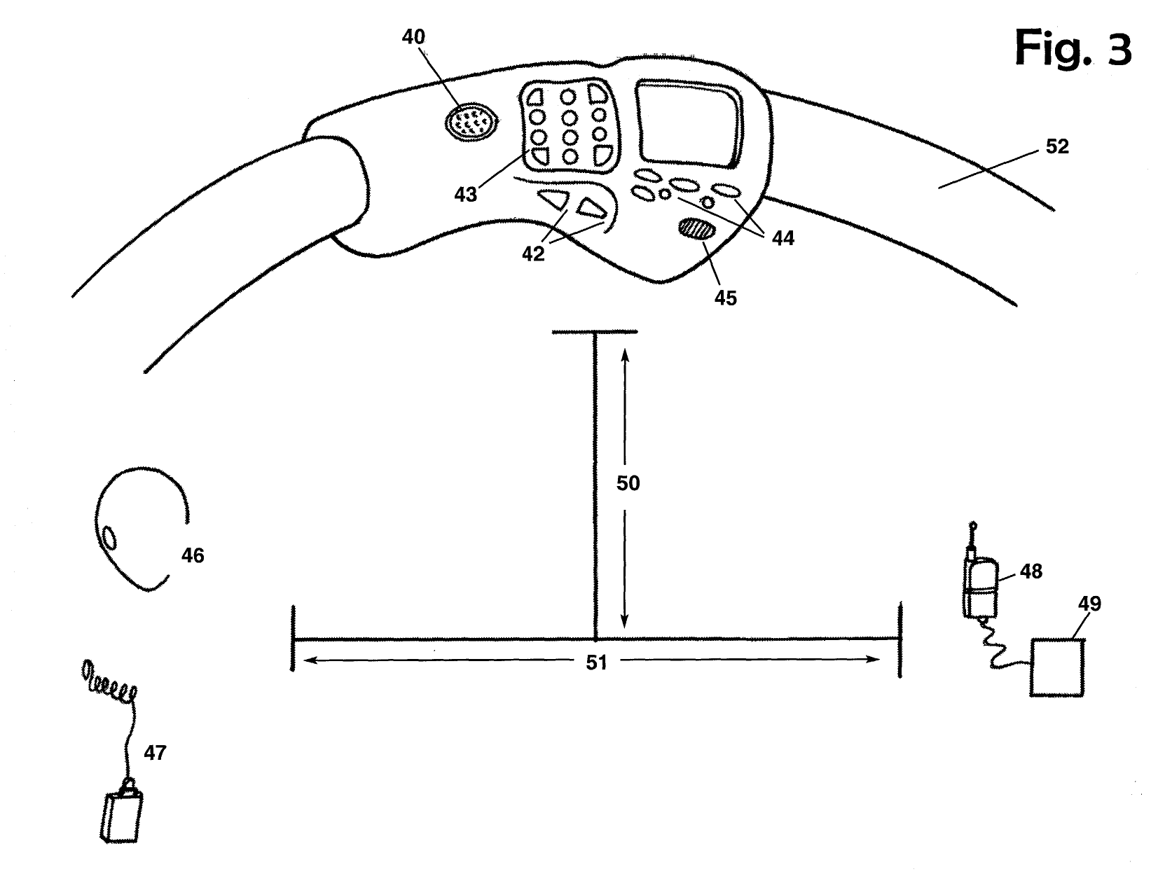

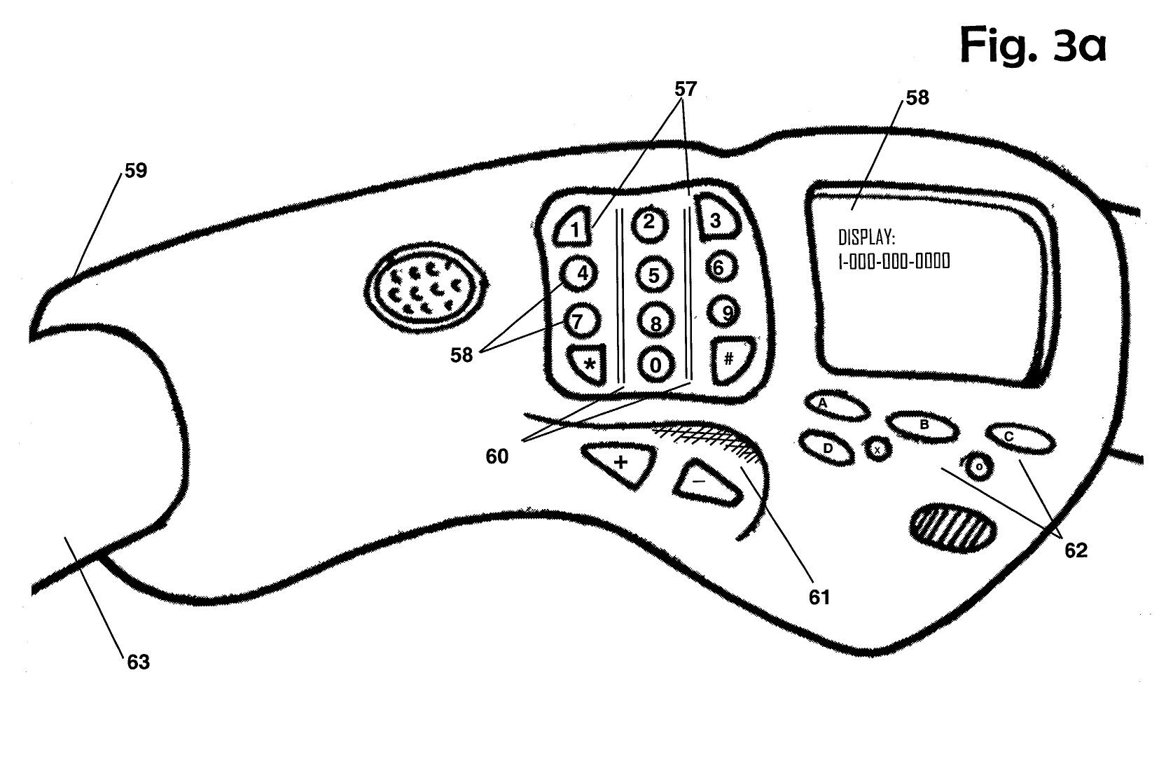

In FIG. 3 “host cell-phone relay-unit holster” 49 may hold various components including a power source. The relay-unit holster 49 may relay rf voice and numeric signals to voice/speech interface. The relay-unit holster 49 may contain and operate rf relay interchange between the MUI, host cell phone, and voice/speech interface. Components within the holster 49 may vary dependent on model type or embodiment to include battery power source, two-way wireless communication circuitry and internet access circuitry.

Given such a device, as described, the outputs for the keys can be provided to a semiconductor to be used by a microprocessor program. Because most microprocessors expect input signals to be in a predetermined format, circuitry is often required to convert signals corresponding to the expected format for the microprocessor. Such circuitry is well known in the art for keypad, internet, and cell-phone devices involved in microprocessor systems.

As regards operation of MUI as an ancillary unit to a host cell phone as displayed in FIG. 3, once the vehicle operator has placed user cell-phone in holster 49, which operates as a remote rf link between the MUI, host cell-phone, and headset; the user may don headset 53 and may initiate dialing sequence using numeric keypad 43. In this embodiment information and voice transfer between host cell, MUI, and headset are all run via rf signal through host cell phone relay unit 49. Other embodiments may elect for direct wire or infrared connection between MUI, host wireless communication device, and voice/speech interface. Other embodiments may additionally elect to gather all components including two-way wireless communication into a single housing.

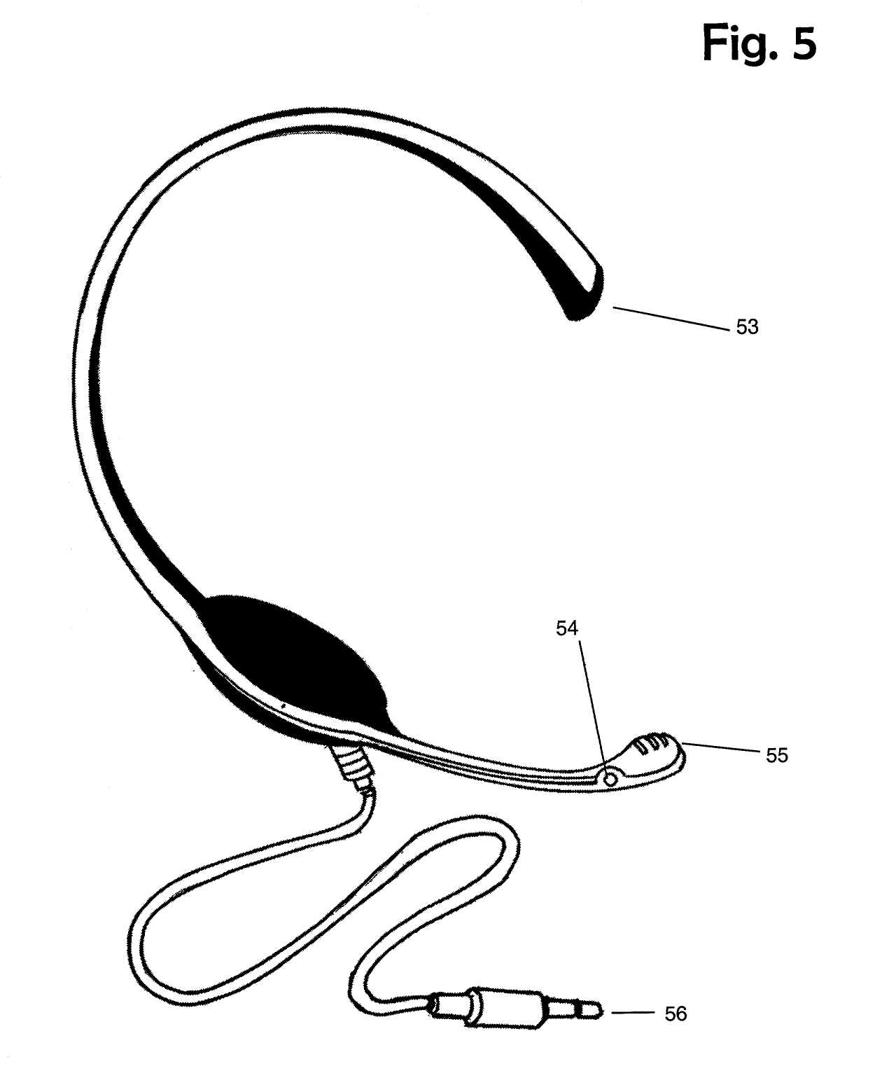

Headset 53 or ear/mouth piece may be attached to ceiling via cable attached to retracting spindle, allowing headset to be retracted and held for potential use at ceiling level without hindering user mobility. When needed headset may be retracted from ceiling by user and quickly attached with one hand for use. Wireless link between ceiling-based headset and MUI marks an improvement over prior art by ensuring user need only temporary and minimum use of one hand, and by allowing left to right mobility of the head and quick accessibility to headset should driving or reception conditions make speakerphone use impractical. FIG. 5 shows headset with infrared linking capability to MUI through infrared sensor 53, placed just above microphone pick-up 55. Headset may be linked to MUI and host cell-phone via remote rf link 50, 51 or by remote infrared connection. FIG. 5 additionally shows direct wire connect between headset and host cell-phone 56.

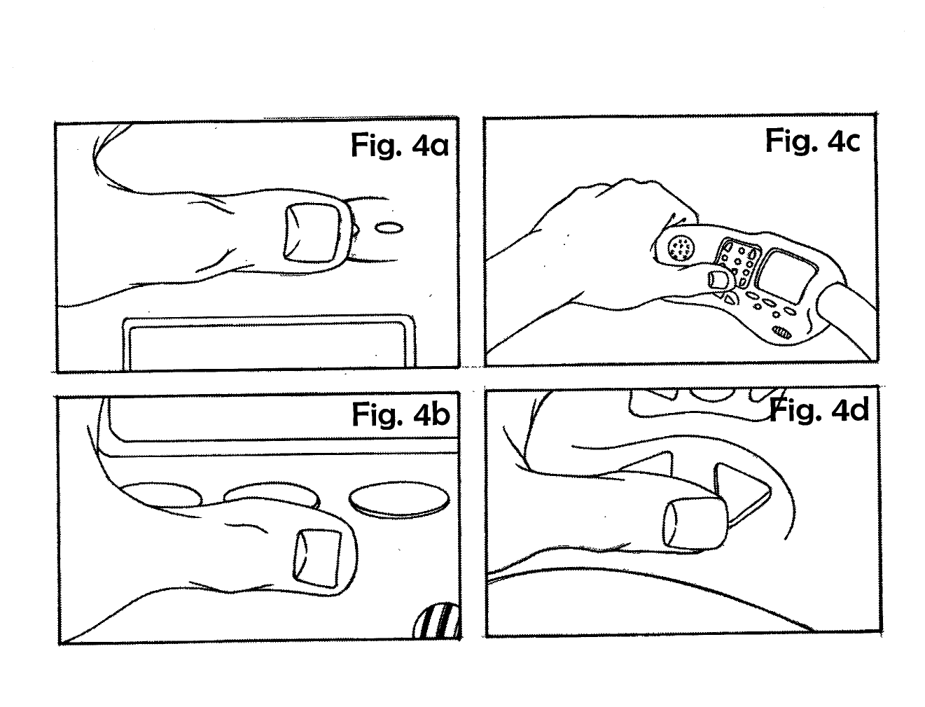

Button layout pattern, 37, 42, 43, 57, 53 juxtaposed button shapes 57, 58 FIG. 3a, FIG. 4b, 4d, and raised markings 2, 5, 58 as represented on each button, draw a distinction to the users touch between button functions, allowing user to dial, receive and field wireless communication operations by touch alone as exhibited in FIGS. 1-4c. In FIG. 3a two opposing arrow shaped keys are set within a depression 61 contoured to the thumb for central orientation to the keys. Raised lettering may be additionally set off-center within keys to lend further tactile operational cues to the operator 58, 62. This by-touch operational method inherent in the various embodiments of the device is additionally wedded to and enabled by finger groove/s and ridges set in the housing of the user interface 6, 7, 4a, 4c, 60, 61 allowing a user to quickly orient hand position relative to key placement.

FIGS. 4a-4d show an embodiment of the Device depicting single-handed by-touch operations using the left hand. Standard transmissions in automobiles require the regular use of the right hand for shifting purposes. In this embodiment, a user positions the left hand in the “key” position FIG. 4c using the contours of the device as quick guides. From the “key” position all buttons along the front of the Device may be depressed with the thumb alone. Round, oval, and arrow shaped keys 57, 58, 62 assist the user in distinguishing the button and key location relative to other keys. For example, arrow shaped keys 57 positioned at the corners of the number-pad 43 point inward to distinguish for the user the boundaries of the number-pad. In this way, the outside rim of numbers can be quickly registered by touch. Additional raised marking on the keys themselves further distinguishes them by touch for the user 43, FIG. 4a. Once a number is dialed as shown in FIG. 4c a connection can be made by depressing the left arrow shaped scroll button in 42, FIG. 3 as further shown in FIG. 4d or terminated as shown in the same figures by pressing the right scroll button 42. FIG. 4a shows the user depressing with the index finger a key on the rear of the fascia reserved for freezing use of facia keys to prevent accidental interruption of calls. With extended pressure the same key may be used to power on or off the device.

The embodiment as shown in FIG. 3, 3a and FIGS. 4a-4d shows additional function keys placed under the display 44, 62 which include but are not limited to phonebook, memory, messaging, and internet functions. These functions maybe varied or expanded, but the keys themselves are designed to be within reach of the thumb for ready and single-handed use. Also, included in this embodiment is a speakerphone function potentially allowing the user to operate the Device as a stand-alone mechanism should it also house, as it may, two-way wireless communication circuitry and internet connectivity. Such circuitry is well known in the art for internet and cell-phone devices.

Having now provided a detailed description of the present invention, it should now be apparent to those skilled in this art that the forgoing is illustrative but not limiting, having been presented by way of example only. Numerous embodiments, other than those illustrated here as means of example, and modifications thereof are contemplated as falling within the scope of the present invention and as defined by the appended claims and equivalents thereto.

What is claimed is:

1. A mechanical user interface (MUI) for a wireless communications device comprising:
a communications keypad coupled to the steering wheel of a motor vehicle
a visual operational display
a method inherent in physical design enabling operation by touch rather than sight

2. The invention in accordance with claim 1 further comprising:
a remote and/or direct communications link to a host cell-phone
a remote and/or direct communications link to a voice/speaker interface or headset

3. The invention in accordance with claim 1 further comprising:
a communications keypad coupled to a steering wheel
a remote and/or direct communications link to a host cell-phone
a remote and/or direct communications link to a voice/speaker interface or headset

4. The invention in accordance with claim 1 further comprising:
a remote and/or direct communications link to a cell phone

5. The invention in accordance with claim 1 further comprising:
wireless communication connectivity

6. The invention in accordance with claim 1 further comprising:
a remote and/or direct communications link to the internet

7. The invention in accordance with claim 1 further comprising:
operational keys placed so as to be positioned on the backside of the steering wheel relative to the vehicle operator

8. The invention in accordance with claim 1 further comprising:
operational keys placed so as to be positioned at the fingertips of the vehicle operator.

9. The invention in accordance with claim 1 further comprising:
raised lettering

10. The invention in accordance with claim 1 further comprising:
raised lettering on keys placed off-center of key as tactile cue

11. The invention in accordance with claim 1 further comprising:
a visual operational-display which rotates, allowing it to be read vertically and horizontally

12. The invention in accordance with claim 1 further comprising:
a rotating visual operational-display capable of maintaining verticality independent of the plain maintained by the MUI control facial.

13. The invention in accordance with claim 1 further comprising:
a speakerphone

14 The invention in accordance with claim 1 further comprising:
a wireless headset

15. The invention in accordance with claim 1 further comprising:
wireless connectivity

16. The invention in accordance with claim 1 further comprising:
a rotating visual operational-display
wireless two-way connectivity
a wireless headset
a speakerphone

17. A method for operation of a mechanical user interface (MUI) for a wireless communications device coupled to the steering wheel of a motor vehicle comprising:
placement of at least one hand on steering wheel in order that a user may initiate or otherwise transact wireless communication through the act of depression of keys on keypad.
tactile operational cues on fascia and housing designed for method of operation not requiring visual cues for operation.
keypad operation through the use of tactile cues on fascia and housing allowing through method and utility a vehicle operator's train of vision to remain unimpeded.

18. The invention in accordance with claim 17 further comprising:
tactile operational cues not requiring visual cues for operation including,
raised lettering on keys

19. The invention in accordance with claim 17 further comprising:
raised lettering on housing

20. The invention in accordance with claim 17 further comprising:
tactile operational cues not requiring visual cues for operation including,
key placement positioned along the backside of steering wheel.

21. The invention in accordance with claim 17 further comprising:
tactile operational cues not requiring visual cues for operation including,
shape and patterning of key arrangement

22. The invention in accordance with claim 17 further comprising:
tactile operational cues not requiring visual cues for operation including,
shape of keys

23. The invention in accordance with claim 17 further comprising:
tactile operational cues not requiring visual cues for operation including,
angle of keys

24. The invention in accordance with claim 17 further comprising:
tactile operational cues not requiring visual cues for operation including,
finger grooves and bumps for orientation of hand along fascia

25. The invention in accordance with claim 17 further comprising:
tactile operational cues not requiring visual cues for operation including,
finger grooves and bumps for orientation of hand along housing

26. The invention in accordance with claim 17 further comprising:
operational keys placed so as to be positioned at the fingertips of the vehicle operator.

27. The invention in accordance with claim 17 further comprising:
tactile operational cues not requiring visual cues for operation including,
operational keys placed so as to be positioned on the backside of the steering wheel relative to the vehicle operator

28. The invention in accordance with claim 17 further comprising:
tactile operational cues not requiring visual cues for operation including,
raised lettering on keys
patterning of key placement
shape of keys
angle of keys
finger grooves and bumps for orientation of user's hand along fascia
finger grooves and bumps for orientation of user's hand along housing
operational keys placed so as to be positioned on the backside of the steering wheel
operational keys placed so as to be positioned at the fingertips of the vehicle operator.

29. A mechanical user interface (MUI) for a wireless communications device comprising:
a communications keypad coupled to the steering wheel of a motor vehicle
a communications keypad capable of being readily uncoupled from the steering wheel of a motor vehicle
keypad operation through the use of tactile cues on fascia and housing
tactile operational cues on fascia and housing designed for method of operation not requiring visual cues for operation

30. The invention in accordance with claim 29 further comprising:
raised lettering on housing

31. The invention in accordance with claim 29 further comprising:
key placement positioned along the backside of steering wheel.

32. The invention in accordance with claim 29 further comprising:
tactile operational cues not requiring visual cues for operation including,
shape and patterning of key arrangement

33. The invention in accordance with claim 29 further comprising:
tactile operational cues not requiring visual cues for operation including,
shape of keys

34. The invention in accordance with claim 29 further comprising:
tactile operational cues not requiring visual cues for operation including,
angle of keys

35. The invention in accordance with claim 29 further comprising:
finger grooves and bumps for orientation of hand along fascia

36. The invention in accordance with claim 29 further comprising:
finger grooves and bumps for orientation of hand along housing

37 The invention in accordance with claim 29 further comprising:
operational keys placed so as to be positioned on the backside of the steering wheel relative to the vehicle operator

38 The invention in accordance with claim 29 further comprising:
finger and/or hand positioning groove/s and/or ridges enabling user orientation by touch to key-pad

39. The invention in accordance with claim 29 further comprising:
tactile operational cues not requiring visual cues for operation including,
raised lettering on keys
patterning of key placement
shape of keys
angle of keys
finger grooves and bumps for orientation of user's hand along fascia
finger grooves and bumps for orientation of user's hand along housing
finger and/or hand positioning groove/s and/or ridges
operational keys placed so as to be positioned on the backside of the steering wheel
operational keys placed so as to be positioned at the fingertips of the vehicle operator.

40. The invention in accordance with claim 29 further comprising:
tactile design orientations on dialing fascia coupled to steering wheel enable a motor vehicle operator to maintain consistent hand contact with the steering wheel, while initiating, fielding, or terminating phone calls through the method of touch.

41. The invention in accordance with claim 29 further comprising:
a dialing key pad coupled to a steering wheel whereon are placed raised numbers, symbols, and/or designators.

42. The invention in accordance with claim 29 further comprising:
a dialing keypad placed on a steering wheel whereon tactile designators assign recognition value meaningful to the user for operating keypad functions on the basis of touch.

43. The invention in accordance with claim 29 further comprising:
an input keypad coupled to a steering wheel
a visual display coupled to steering wheel
a headset coupled via a retractable cable

44. The invention in accordance with claim 29 further comprising:
a visual display coupled to vehicle console

45. The invention in accordance with claim 29 further comprising:
a visual display placed along a driver's line of sight to the road.

46. The invention in accordance with claim 29 further comprising:
a rotational visual operational-display capable of being read by the operator independently of the vertical or horizontal positioning of the MUI control fascia.

47. The invention in accordance with claim 29 further comprising:
an interfacing link to a host wireless communications device

48. The invention in accordance with claim 29 further comprising:
an input keypad coupled to a steering wheel
an interfacing link between voice/speech interface, input keypad, and cell phone
